(19) United States
(12) Patent Application Publication
(10) Pub. No.: US 2014/0233529 A1
(43) Pub. Date: Aug. 21, 2014

(54) SELECTING A TYPE OF CIRCUIT SWITCHED FALLBACK

(71) Applicant: QUALCOMM Incorporated, San Diego, CA (US)

(72) Inventors: Rajat PRAKASH, San Diego, CA (US); Masakazu SHIROTA, Yokohama-shi (JP)

(73) Assignee: QUALCOMM Incorporated, San Diego, CA (US)

(21) Appl. No.: 14/177,774

(22) Filed: Feb. 11, 2014

Related U.S. Application Data
(60) Provisional application No. 61/767,638, filed on Feb. 21, 2013.

(51) Int. Cl. H04W 36/00

(52) U.S. Cl. CPC H04W 36/0022
USPC 370/331

(57) ABSTRACT

A type of circuit switched fallback (CSFB) is selected based on the target access point for the CSFB. For example, redirection-based CSFB may be selected for some types of target access points, while handover-based CSFB is selected for other types of target access points. In some aspects, an entity may use one or more access point identifiers associated with the target access point to select which type of CSFB to use.

### CROSS-REFERENCE TO RELATED APPLICATIONS

The present Application for Patent claims the benefit of U.S. Provisional Application No. 61/767,638, entitled “CIRCUIT SWITCHED FALLBACK FOR SMALL CELL DEPLOYMENT”, filed Feb. 21, 2013, assigned to the assignee hereof, and expressly incorporated herein by reference in its entirety.

### BACKGROUND

This application relates generally to wireless communication and more specifically, but not exclusively, to circuit switched fallback.

A wireless communication network may be deployed to provide various types of services (e.g., voice, data, multimedia services, etc.) to users within a coverage area of the network. In some implementations, one or more access points (e.g., corresponding to different cells) provide wireless connectivity for access terminals (e.g., cell phones) that are operating within the coverage of the access point(s).

In some networks, low-power access points (e.g., femto cells) are deployed to supplement conventional network access points (e.g., macro access points). For example, a low-power access point installed in a user's home or in an enterprise environment (e.g., commercial buildings) may provide voice and high speed data service for access terminals supporting cellular radio communication (e.g., CDMA, WCDMA, UMTS, LTE, etc.). In general, these low-power access points provide more robust coverage and higher throughput for access terminals in the vicinity of the low-power access points.

Various types of low-power access points may be employed in a given network. For example, low-power access points may be implemented as or referred to as small cells, femto cells, femto access points, femto nodes, home NodeBs (HNBs), home eNodeBs (HeNBs), access point base stations, pico cells, pico nodes, or micro cells. For convenience, low-power access points may be referred to simply as small cells in the discussion that follows. Thus, it should be appreciated that any discussion related to small cells herein may be equally applicable to low-power access points in general (e.g., to femto cells, micro cells, pico cells, etc.).

Small cells may be deployed in enhanced packet-based networks such as LTE networks. Some deployments of packet-based networks (e.g., LTE) might not support 100% packet-based service. For example, mobile devices and access points on an LTE network might not support Voice-over-LTE (VoLTE). Accordingly, a packet-based network may support fallback to circuit switched (CS) technology for making voice calls. This fallback procedure is commonly referred to as circuit switched fallback (CSFB). To support both packet traffic and CS voice service, a network will deploy packet-based access points (e.g., LTE eNBs) and CS access points (e.g., CDMA 1xRTT base stations). For convenience, the discussion that follows may simply refer to LTE and 1x. It should be appreciated, however, that the teachings herein may be applicable to other technology.

FIG. 1 illustrates an example of a small cell deployment 100 where a small cell 102 supports both LTE and 1x and there is overlapping coverage for LTE and 1x. In addition, CS fallback is only provided within coverage of the small cell 102. For example, the small cell 102 may comprise a pico cell deployment where a 1x femto cell is collocated with an LTE pico cell. An LTE UE (LTE access terminal) 108 that is served by the pico cell can initiate a CS call by using the corresponding collocated 1x femto cell. As CS fallback from the LTE pico cell to a 1x macro cell (not shown) is not supported, the coverages 104 and 106 of the collocated LTE pico cell and 1x femto cell are configured to be identical. This is known as coverage matching.

FIG. 2 illustrates an example of non-overlapping coverage for LTE and 1x. Specifically, coverage 202 for a macro cell is larger than coverage 204 for an LTE small cell, and coverage 206 for a 1x cell is smaller yet. In this case, CS fallback from LTE to a 1x macro cell or to a 1x small cell is supported depending on the location of the UE. In the example of FIG. 1, the small cell 108 includes both an LTE eNB and a 1x cell.

There are several advantages that may result from avoiding coverage matching and, instead, have the option of CS fallback from the small cell eNB to the 1x macro.

For example, for a scenario employing a dedicated channel LTE small cell and a co-channel small cell 1x and a macro cell 1x, coverage match is challenging between the small cell LTE and 1x, primarily due to differences in interference between 1x and LTE channels. The 1x small cell sees macro interference, and hence may end up with smaller coverage than LTE. This leads to scenarios where CSFB from small cell LTE to macro cell 1x is desired.

As another example, for a scenario employing a dedicated channel LTE small cell and a dedicated channel small cell 1x, coverage match is less challenging because there is no macro interference on 1x. However, even in this scenario the cross-channel interference concerns may require that the small cell 1x transmits at a reduced power, thereby leaving the small cell LTE with larger coverage than the small cell 1x. This again leads to scenarios where CSFB from a small cell LTE to macro cell 1x is desired.

Different types of CSFB have been developed as network architectures have evolved. In redirection-based CSFB to 1x (e.g., for LTE Rel. 8 CSFB), the network instructs a UE to go to a particular 1x frequency and perform 1x access procedures. In contrast, handover-based CSFB to 1x (e.g., for LTE Rel. 9 CSFB, also known as enhanced CSFB) relies on a handover command to the UE, instead of a redirection command. In general, handover-based CSFB provides better performance than redirection-based CSFB, at the expense of a more complex interconnect from the network side. Thus, in some cases it is desirable to perform handover-based CSFB (e.g., where the added complexity is not a significant problem), while in other cases it is desirable to perform redirection-based CSFB (e.g., where the added complexity may be a significant problem).

### SUMMARY

A summary of several sample aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to facilitating CS fallback (e.g., from an LTE small cell to a 1x macro cell). In some aspects, a type of CSFB to be used for CSFB of an access terminal to a target access point is selected based on one or more criterion.

The disclosure relates in some aspects to selecting a type of CSFB to use based on the target access point for the CSFB. For example, redirection-based CSFB may be selected for some types of target access points, while handover-based CSFB is selected for other types of target access points. To this end, access point identifiers may be used to select which type of CSFB to use.

Other procedures may be employed to facilitate CSFB. For example, a procedure is disclosed for determining the target identifier to be used for CSFB. Also, a hybrid automatic neighbor relations (ANR) procedure is disclosed for identifying neighbor cells.

The teachings herein may be embodied and/or practiced in different ways in different implementations. Several examples follow.

In some aspects, an apparatus for communication in accordance with the teachings herein comprises: a receiver configured to receive an identifier for an access point from an access terminal; and a processing system configured to select, based on the received identifier, a type of circuit switched fallback procedure to use for circuit switched fallback of the access terminal to the access point.

In some aspects, a method of communication in accordance with the teachings herein comprises: receiving an identifier for an access point from an access terminal; and selecting, based on the received identifier, a type of circuit switched fallback procedure to use for circuit switched fallback of the access terminal to the access point.

In some aspects, an apparatus for communication in accordance with the teachings herein comprises: means for receiving an identifier for an access point from an access terminal; and means for selecting, based on the received identifier, a type of circuit switched fallback procedure to use for circuit switched fallback of the access terminal to the access point.

In some aspects, a computer-program product in accordance with the teachings herein comprises computer-readable medium comprising code for causing a computer to: receive an identifier for an access point from an access terminal; and select, based on the received identifier, a type of circuit switched fallback procedure to use for circuit switched fallback of the access terminal to the access point.

### BRIEF DESCRIPTION OF THE DRAWINGS

These and other sample aspects of the disclosure will be described in the detailed description and the claims that follow, and in the accompanying drawings, wherein:

FIG. 1 is a simplified diagram illustrating an example of a small cell deployment;

FIG. 2 is a simplified diagram illustrating an example of a large cell and small cell deployment;

FIG. 3 is a simplified block diagram illustrating an example of a communication system configured to support selection of a type of CSFB;

FIG. 4 is a flowchart of several sample aspects of operations that may be performed in conjunction with selecting a type of CSFB;

FIG. 5 is a simplified block diagram illustrating an example of nodes involved in CSFB;

FIG. 6 is a simplified call flow for redirection-based CSFB;

FIG. 7 is a simplified call flow for handover-based CSFB;

FIG. 8 is a simplified block diagram illustrating an example of a communication system employing small cells;

FIG. 9 is a simplified call flow relating to an example of a mobile originated scenario;

FIG. 10 is a simplified call flow relating to an example of a mobile terminated scenario;

FIG. 11 is a simplified call flow relating to an example of eCSFB on an LTE network;

FIG. 12 is a flowchart of several sample aspects of operations that may be performed in conjunction with determining an access point identifier for CSFB;

FIG. 13 is a flowchart of several sample aspects of operations that may be performed in conjunction with a hybrid ANR procedure;

FIG. 14 is a simplified block diagram of several sample aspects of components that may be employed in a communication node;

FIG. 15 is a simplified diagram of a wireless communication system;

FIG. 16 is a simplified diagram of a wireless communication system including small cells;

FIG. 17 is a simplified diagram illustrating coverage areas for wireless communication;

FIG. 18 is a simplified block diagram of several sample aspects of communication components;

FIGS. 19-21 are simplified block diagrams of several sample aspects of apparatuses configured to support CSFB as taught herein; and

FIG. 22 is a simplified block diagram of several sample aspects of a processing circuit and a computer-readable medium that supports CSFB as taught herein.

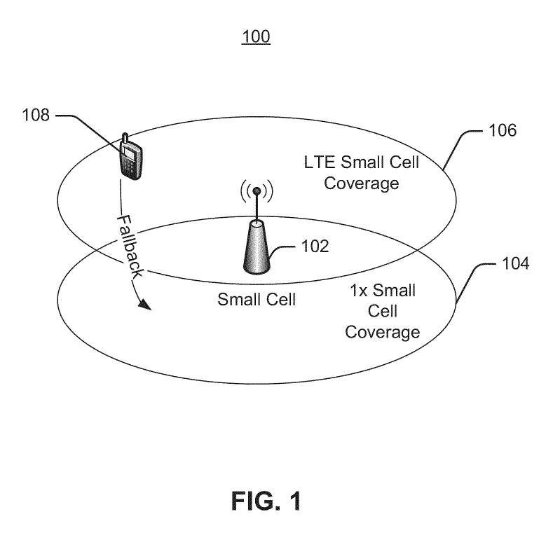

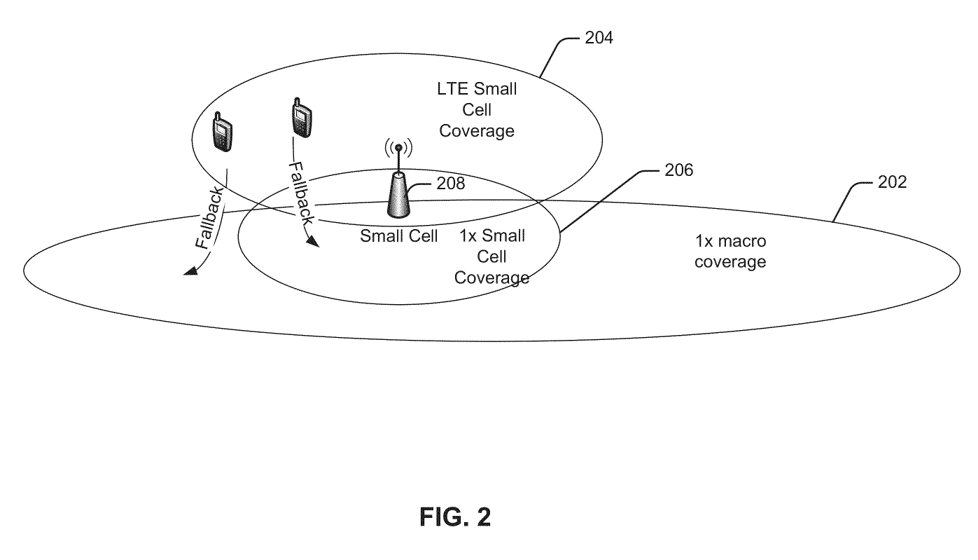

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

A decision regarding the particular type of CSFB to be used for CSFB to a given target access point is selected based on the specific target access point. For example, redirection-based CSFB may be selected for some types of target access points, while handover-based CSFB is selected for other types of target access points. Accordingly, one or more parameters (e.g., identifiers) associated with the target access point may be used to select the type of CSFB to be used for the CSFB.

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, any aspect disclosed herein may be embodied by one or more elements of a claim. For convenience, the term some aspects may be used herein to refer to a single aspect or multiple aspects of the disclosure.

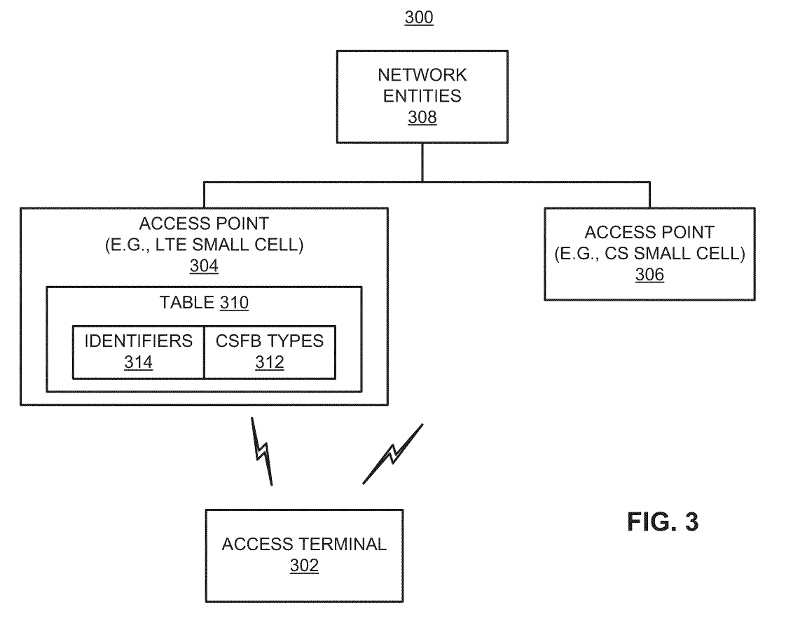

FIG. 3 illustrates several nodes of a sample communication system 300 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, small cells, macro cells, femto cells, and so on, while access terminals may be referred to or implemented as user equipment (UEs), mobile stations, and so on.

Access points in the system 300 provide access to one or more services (e.g., network connectivity) for one or more wireless terminals (e.g., the access terminal 302) that may be installed within or that may roam throughout a coverage area of the system 300. For example, at various points in time the access terminal 302 may connect to the access point 304, the access point 306, or some other access point in the system 300 (not shown).

One or more of the access points may communicate with one or more network entities (represented, for convenience, by the network entities 308), including each other, to facilitate wide area network connectivity. Two or more of such network entities may be co-located and/or two or more of such network entities may be distributed throughout a network.

A network entity may take various forms such as, for example, one or more radio and/or core network entities. Thus, in various implementations the network entities 308 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals.

To facilitate CSFB in accordance with the teachings herein, the access point 304 determines a type of CSFB to use for CSFB of the access terminal 302 to the access point 306 (or any other CS-capable access point in the network). For example, the access point 304 may determine the type of CSFB based on one or more identifiers of the access point 306.

An access point may be assigned different types of identifiers. A local identifier such as a physical layer identifier (e.g., a PN) may uniquely identify an access point at a local level (e.g., within a macro cell). In addition, a global identifier such as a cell identifier (e.g., a Cell ID) may uniquely identify an access point at a more global level (e.g., within an operator's network). Since the first type of identifier is smaller in size, it may be more efficiently broadcast by an access point. Hence, this type of identifier is used locally to identify access points.

In the example of FIG. 3, the access point 304 maintains a table 310 that serves to map different potential target access points with different types of CSFB 312. Specifically, for a given access point, the table 310 maps the access point to the type of CSFB supported by that access point. Due to their global uniqueness, the access point 304 may use identifiers 314 of the second type for the CSFB table. That is, the table 310 may map identifiers 314 of a second type to a corresponding type of CSFB 312. For example, some of the identifiers 314 in the table 310 may be mapped to LTE Rel. 8 CSFB, while other identifiers may be mapped to LTE Rel. 9 CSFB.

At some point in time, the access point 304 receives information from the access terminal 302 currently being served by the access point 304. For example, the access point 304 may receive a measurement report message that includes an identifier of the first type (e.g., a local identifier) for the access point 306 (a potential target access point). The access point 304 then determines an identifier of the second type (e.g., a global identifier) for the potential target access point 306 based on the identifier of the first type. Consequently, the access point 304 can select a type of CSFB procedure to use for CSFB of the access terminal 302 to the potential target access point 306 based on the table 310 and an identifier received from the access terminal 302.

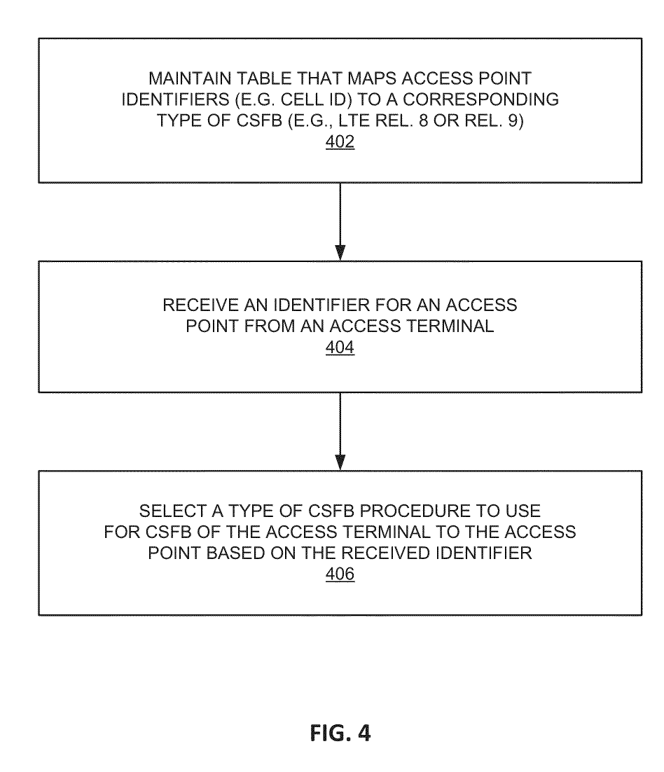

Several operations relating to selecting a type of CSFB in accordance with the teachings herein will now be described in more detail with reference to FIG. 4. For convenience, the operations of FIG. 4 (or any other operations discussed or taught herein) may be described as being performed by specific components. It should be appreciated, however, that these operations may be performed by other types of components and may be performed using a different number of components. For example, the operations of FIG. 4 may be implemented in an access point, a network entity, or some other suitable type of device. It should be appreciated that one or more of the operations described herein may not be employed in a given implementation.

In some implementations, the operations of FIG. 4 are performed at an apparatus that comprises co-located access points employing different radio access technologies (e.g., LTE and CDMA 1xRTT). As used herein, the term co-located can mean, for example, in varying degrees: that the access points are mounted on shared mounting equipment (e.g., within the same housing), that the access points are on the same antenna tower, that the access points share transmission antennas, that there is a defined distance (e.g., less than 15 meters) between the access points, or that one access point is within the coverage of another access point.

As represented by block 402 of FIG. 4, a serving access point (e.g., a small cell eNodeB) maintains a table that maps access points identifiers (e.g., global identifiers) to a corresponding type of CSFB. As discussed herein, some identifiers may be mapped to LTE Rel. 8 CSFB, while other identifiers may be mapped to LTE Rel. 9 CSFB. Thus, in some aspects, the table indicates, for each of a plurality of access point identifiers, whether an access point associated with the access point identifier supports LTE Rel. 8 CSFB or LTE Rel. 9 CSFB. In some implementations, the serving access point provisions the table. For example, the provisioning of the table may involve receiving table information (e.g., indicative of the correlation between access point identifiers and types of CSFB) from a configuration management entity (e.g., a network entity that is external to the serving access point).

As represented by block 404, the serving access point receives an identifier for a potential target access point from an access terminal. For example, the serving access point may receive a measurement report from the access terminal, where the measurement report includes a local access point identifier detected by the access terminal. In some aspects, the identifier may comprise a global identifier (e.g., a cell identifier) that is unique within an operator network.

As represented by block 406, the serving access point selects a type of CSFB procedure to use for CSFB of the access terminal to the potential target access point. In some aspects, the selection of the type of circuit switched fallback procedure comprises selecting between LTE Rel. 8 CSFB and LTE Rel. 9 CSFB.

In some aspects, the selection of block 406 may be based on the identifier received at block 404. For example, the serving access point may map a received local identifier to a global identifier.

In some aspects, the selection of the type of CSFB procedure may be based on the table maintained at block 402. In this case, the serving access point may look up the identifier (e.g., the global identifier) in the table to identify the corresponding CSFB type listed in the table.

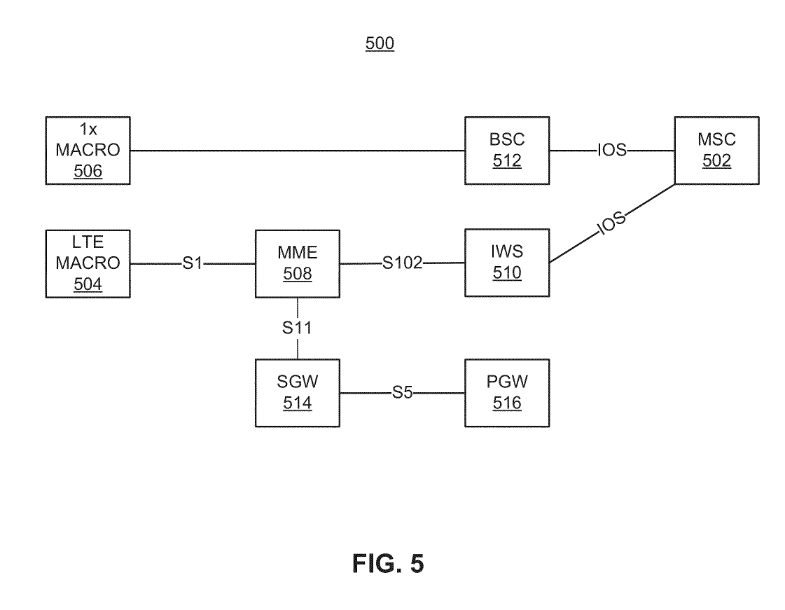

With the above in mind, additional details relating to CSFB will now be described with reference to FIGS. 5-11.

Initially, a high level introduction to CSFB will be presented. Circuit switched fallback has been defined in 3GPP (TS 23.272). Accordingly, for purposes of explanation, CSFB will be described in the context of a UMTS system 500 of FIG. 5 that depicts sample nodes that may be involved in CSFB for 3GPP. It should be appreciated, however, that the principles that follow may be applicable to other types of nodes and technologies.

An S102 interface is defined in 3GPP TS 29.277. This interface allows a UE (not shown) with service on LTE in radio resource control (RRC) Idle state or RRC Connected state to register with a 1x mobile switching center (MSC) 502, via the transport of registration messages encapsulated in LTE protocols. Here, signalling is passed via a mobility management entity (MME) 508 and an interworking solution (IWS) 510. Connectivity to an external packet network is provided via the serving gateway (SGW) 514 and the packet data network (DN) gateway (PGW) 516.

While the UE is registered with the MSC 502, the UE can turn its 1x radio off, and need not monitor paging on 1x. The 1x pages are tunnelled via LTE instead.

When a CS call is initiated, the UE first connects to the LTE system (e.g., the LTE macro 504), which in turn commands the UE to go to 1x (e.g., the 1x macro 506). Once the UE is on 1x, signalling is routed via a base station controller (BSC) 512. The CSFB procedures do not allow the UE to autonomously go to 1x, the main reason being that the UE is expected to take a long time to find a 1x target frequency and/or known cell because the 1x radio is off

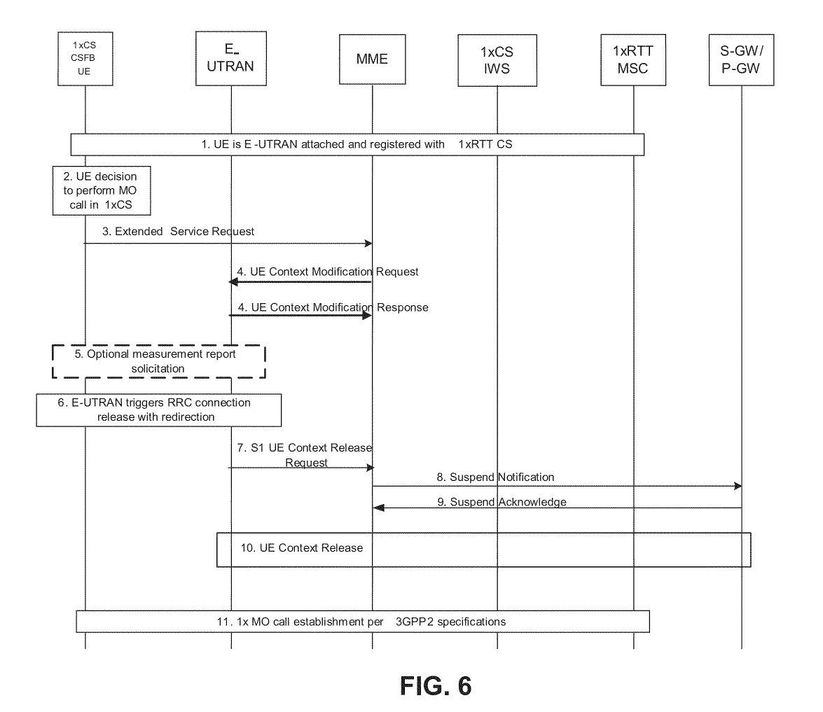

FIG. 6 illustrates an example of call flow for redirection-based CSFB (LTE Rel. 8 CSFB). This example depicts a mobile originated (MO) call using fallback to CDMA 1x. In redirection-based CSFB, the network instructs the UE to go to a particular 1x frequency and perform 1x access procedures. A UE that is attached in E-UTRAN and registered with 1x (operation 1) decides to perform a mobile originated call in 1x CS (operation 2). An extended service request (operation 3) and UE context messaging (operation 4) follows. The E-UTRAN may optionally solicit a measurement report from the UE (operation 5). At operation 6, E-UTRAN triggers an RRC connection release. This results in context release and suspend signalling (operations 7-10). The UE then establishes a call with the 1x MSC (operation 11). Further details of the call flow can be found in 3GPP TS 23.272.

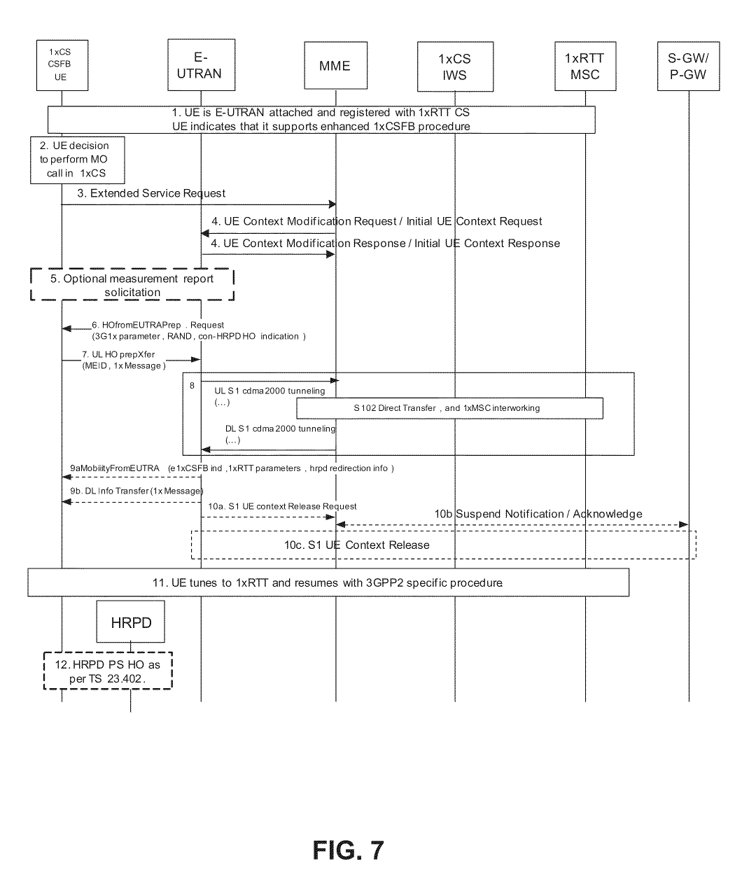

FIG. 7 illustrates call flow for handover-based CSFB (LTE Rel. 9 CSFB). This example depicts CS MO Enhanced CS fallback to 1xRTT. The Rel-9 CSFB procedure, also known as eCSFB relies on a handover command to the UE, instead of a redirection command. This enables the UE to go to a traffic channel on 1x directly, without using the 1x access channel. A UE that is attached in E-UTRAN and registered with 1x (operation 1) decides to perform a mobile originated call in 1xCS (operation 2). An extended service request (operation 3) and UE context messaging (operation 4) follows. The E-UTRAN may optionally solicit a measurement report from the UE (operation 5). Handover preparation is performed at operations 6 and 7. Operation 8 involves cdma2000 tunnelling for direct transfer and 1xMSC interworking. Operation 9 involves mobility from EUTRA and downlink information transfer. After context release (operation 10) the UE tunes to 1x (operation 11). High rate packet data services also may be supported (operation 12). Further details of the call flow can be found in 3GPP TS 23.272.

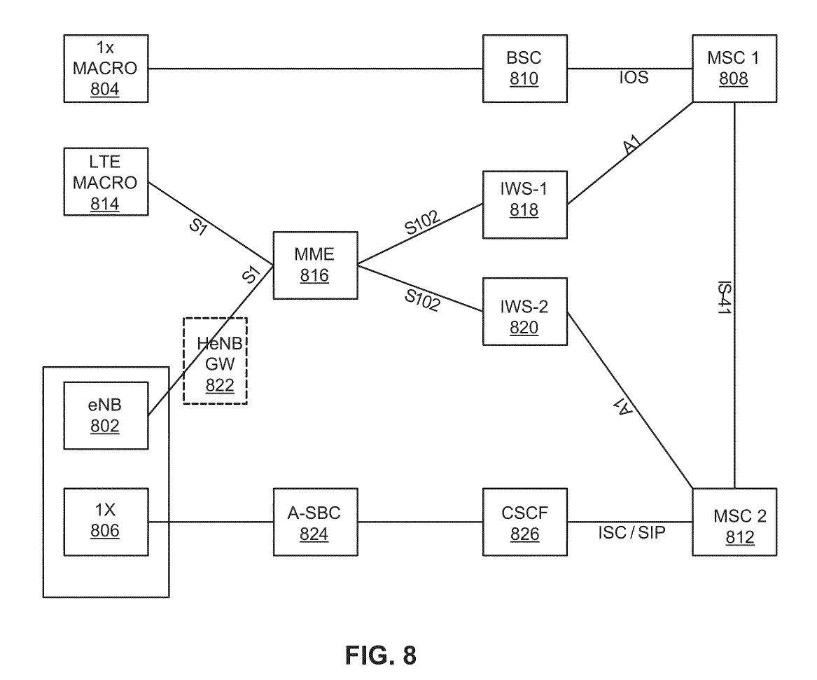

Referring now to FIGS. 8-11, an example of a procedure for achieving fallback from a small cell (e.g., a small cell eNB 802) to a 1x macro cell 804 will be described. In this example, it is assumed that small cells are deployed with the simplified architecture model of FIG. 8. A 1x small cell 806 connects to the CS core via an IMS subsystem defined in 3GPP2 X.50059-200-A. The 1x macro cell 804 connects to an MSC 808 via a BSC 810 in a classical architecture. Note that the IMS nature of the connection of the 1x small cell is not a concern here, because fallback to the 1x macro cell 804 does not involve any of the IMS nodes. Only the MSC 812 that controls the IMS function participates in call setup.

An LTE macro eNB 814 and the small cell eNB 802 both connect to a common MME 816, which connects to the 1x MSCs 808 and 812 via respective interworking solutions (functions) 818 and 820. A common MME 816 is assumed here for the small cell and macro systems, though it is not critical to the proposed solution. As indicated, in some implementations, the small cell eNB 802 may be managed by a Home eNB gateway (HeNB GW) 822.

The solution to handle enhanced CSFB (eCSFB) from a UE under a small cell eNB to a 1x macro cell may have the following four components. Before call setup, the eNB maintains a table mapping the PilotPN code (PN) to the “1x Reference Cell ID” of the 1x neighbors, including macro cell(s) and small cell 1x cells. The eNB uses 1x measurement reports to identify whether fallback to a 1x macro cell or a 1x small cell is needed. The eNB sends the “1x Reference Cell ID” to the core network, which uses it to route the message to the appropriate MSC which controls the target 1x cell. The procedures for unsolicited call handling in the MSC are used to connect the call if the UE was not registered at the MSC.

In accordance with the teachings herein, an alternative solution can use Rel-8 CSFB to handle fallback to a macro cell. In this case, depending on the reference cell ID of the target cell, the small cell eNB decides whether to initiate CSFB or eCSFB.

Also in accordance with the teachings herein, a small cell may maintain a 1x Reference Cell ID neighbor table (e.g., at the small cell or elsewhere in the network). A neighbor table may be used by the small cell to map the UE's reported 1x PilotPN to a globally unique Reference Cell ID. Three examples of solutions to maintain this mapping for 1x neighbors of the small cell follow.

The first example is based on network listening. The small cell can use a Network Listening Module (NLM) to monitor the overhead of 1x neighbors, and build a neighbor relations table. However, this technique has some limitations in the “hidden node” case, where the UE served by a small cell sees a 1x neighbor that is not observable to the NLM.

The second example is based on UE automatic neighbor relations (ANR). The 3GPP standard defines inter-RAT ANR, where the UE can read 1x overheads and provide them to the serving cell. This solution overcomes the “hidden node” limitations of NLM. However, UEs might not widely support this feature in practice.

The third example is deemed hybrid ANR. In case the 1x neighbor is collocated with an LTE neighbor, it is possible to use intra-RAT LTE ANR for the small cell to discover the corresponding LTE neighbor. After this discovery, messaging (e.g., proprietary backhaul messaging) with that LTE neighbor can be used to learn the PN and Cell IDs of the corresponding 1x cell at the neighbor. This method is suitable if the coverage of the LTE neighbor is greater than or equal to the corresponding 1x cell.

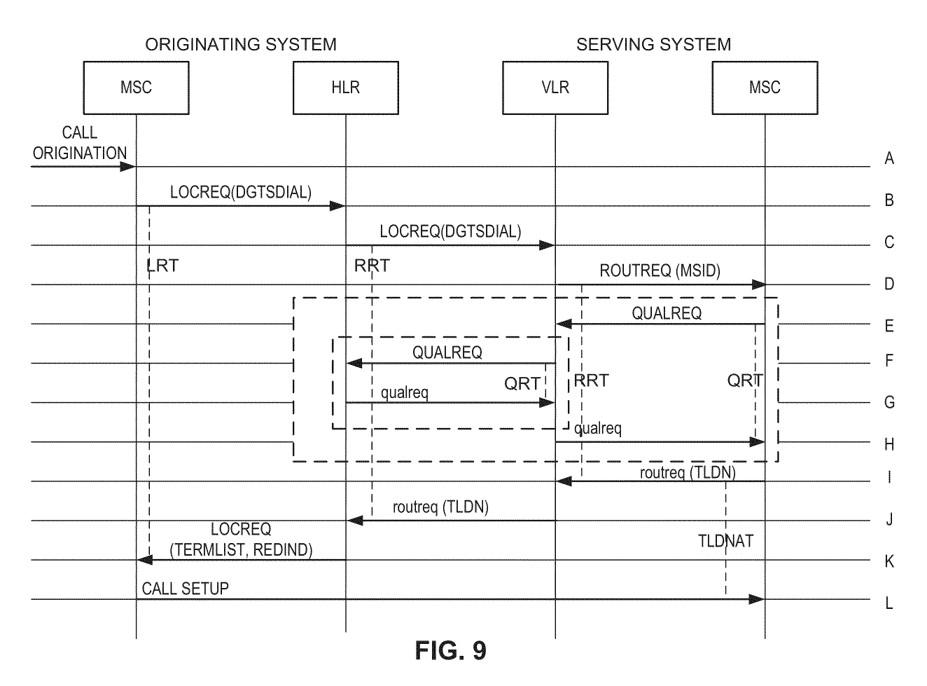

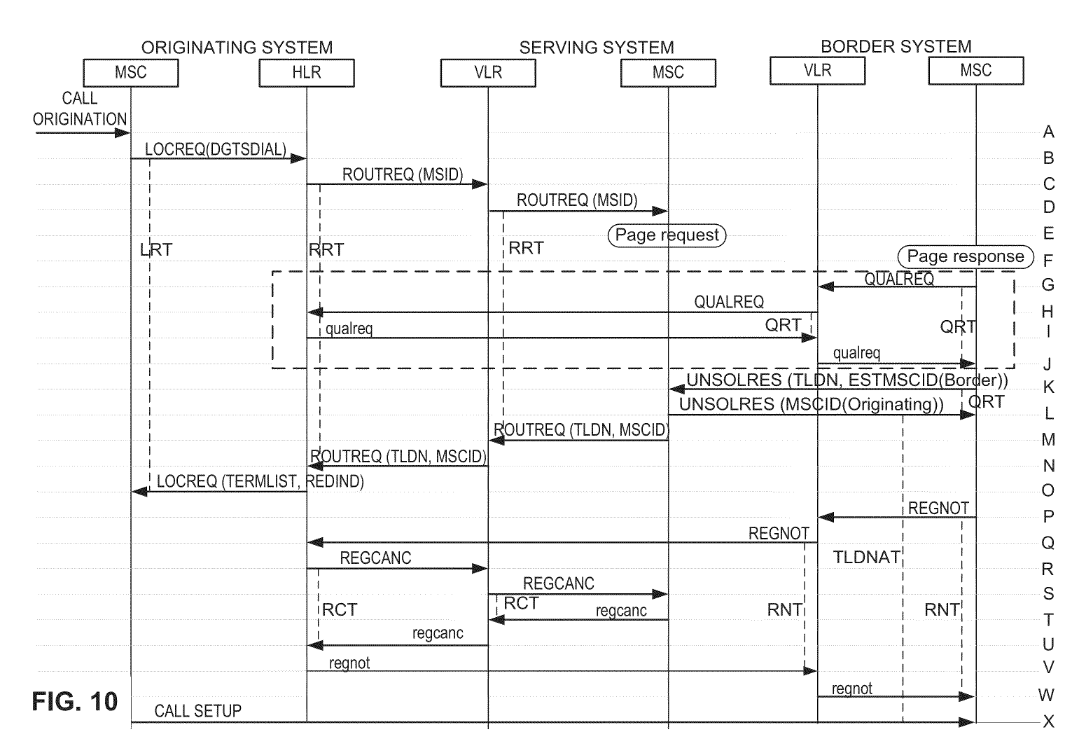

Referring to FIGS. 9 and 10, two example of unsolicited call handling at the MSC are described. The specification 3GPP2 X.S0004-321-E defines the handling of a call arriving at a MSC that does not have the UE's registration.

FIG. 9 illustrates a mobile originated (MO) scenario. This case involves call invocation on an idle mobile station (e.g., UE) on another MSC. In the call flow of FIG. 9, it does not matter whether the MSC in the originating system has a preregistration from the UE. Rather, a registration update can happen during or after the call is complete. Hence, this scenario may be handled without significant impact to MCS 2 (FIG. 8).

FIG. 10 illustrates a mobile terminated (MT) scenario. This case involves call invocation with an unsolicited page response. A call flow for the MT case is provided in Section 1.8 of the 3GPP2 C.S0004-E-321.

Of note, in supporting page response at an MSC, the mobile station is not registered in operation ‘k’, where the new MSC sends an UnsolicitedResponse (UNSOLRES) message to the serving MSC. The UNSOLRES message is defined in Section 2.77 of 3GPP2 X.S0004-540-E “Mobile Application Part (MAP)—OPERATIONS SIGNALING PROTOCOLS”.

If the procedures in this call flow are supported between MSC 2 and the macro MSC (MSC 1), then MT calls can be supported for fallback from small cell to macro cell.

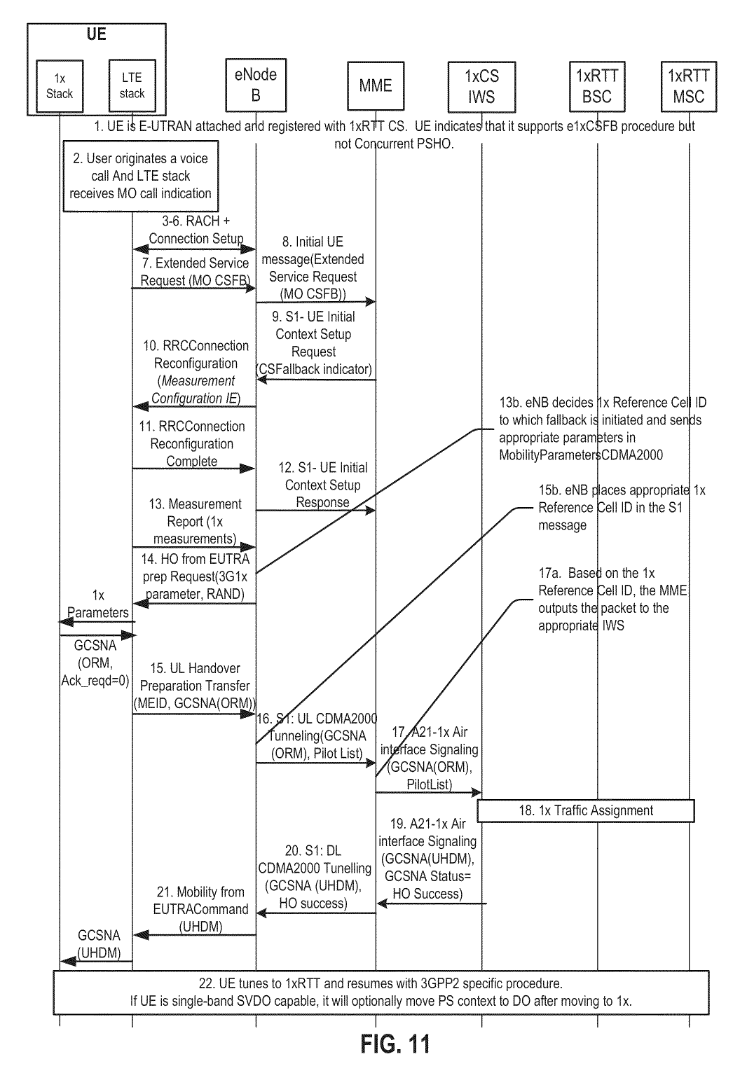

Referring now to FIG. 11, an example of eCSFB handling on an LTE network is described. This example involves eCSFB for the MO case with inter-system handling. Assuming that the MSC supports the procedures of FIGS. 9 and 10 (i.e., unsolicited call handling), the flow for eCSFB will be as follows.

At operation 1, the UE is E-UTRAN attached and has completed the registration with the 1x network. The UE has informed the E-UTRAN network that it is capable of enhanced 1xCS fallback but it does not support concurrent CS+PS HO.

At operation 2, the user (UE) initiates an MO voice call and the LTE stack receives an MO call indication trigger. If the MO call trigger passes through the 1x stack, the 1x stack will run a PSIST check before sending the MO call indication trigger to the LTE stack. The PSIST check uses the 1xACB learnt in system information block 8 (SIB-8). A random number is selected, and if the random number is less than the 1xACB value for MO calls, the MO call indication trigger is sent to the LTE stack.

At operation 3, a trigger causes the LTE NAS layer to initiate an Extended Service Request (1xCSFB MO-call) being sent to the RRC layer. The RRC layer in turn starts the random access (RA) channel (RACH) procedure by sending the RA Preamble.

At operation 4, the eNodeB sends an RA Preamble Response which contains the TimingAdvance, UL Grant, and Temp C-RNTI.

At operation 5, the UE sends the RRC-Connection request message. This message contains an indication that it is for MO-Data. It also contains UE Contention Resolution Identity MAC control element.

At operation 6, the eNodeB responds with a RRC-Connection Setup message that contains a UE Contention Resolution Identity identical to that in operation 6. Upon reception of this the UE considers contention resolution phase to have concluded.

At operation 7, the UE sends a RRC-Connection Setup Complete message. This message contains the Extended Service-Request NAS message.

At operation 8, upon receiving the RRC-Connection Setup Complete message, the eNodeB extracts the NAS message and sends it to the MME in a S1-Initial UE message.

At operation 9, the MME sends the S1-Initial Context Request message to the eNodeB. This message contains the bearers that should be set up for the UE. It also contains the CS Fallback Indicator IE that informs the eNodeB that the CS Fallback procedure is to be performed.

At operation 10, the eNodeB sets up the radio bearers based on the S1-Initial Context Request. It sends a RRC-Radio Reconfiguration message to the UE with configurations at the bearer, MAC and PHY layers. The message also configures 1x measurement objects. The recommendation is for the eNodeB to only configure 1x measurement objects and no DO or LTE measurement objects.

The eNodeB can request measurement of one 1x band/carrier in the measurement object or multiple 1x bands per measurement object.

At operation 11, the UE responds with an RRC-Radio Reconfiguration Complete message.

At operation 12, the eNodeB sends an S1-Initial Context Response message to indicate which of the E-RABs has been established.

At operation 13, once the UE has completed measuring the 1x channels and pilots configured by the eNodeB, it sends a measurement report.

At operation 13b, upon receiving the measurement report, the eNodeB determines which 1x pilot is most suitable for CS fallback, and determines a Reference Cell ID corresponding to that 1x pilot based on its 1x neighbor relations table.

Depending on eNodeB configuration, if the measurement report indicates that the 1x channel is not satisfactory, the measurement configuration and reporting operations might be repeated.

At operation 14, the eNodeB sends a HO from EUTRA Preparation Request Command to the UE. This handover (HO) message contains the 1xParameters including the RAND value, corresponding to the 1x pilot selected for fallback.

At operation 15, upon receiving the 1x parameters, the 1x stack prepares the ORM and encapsulates it in a GCSNA 1x Circuit Service message. This message is sent to eNodeB in a UL-Handover Preparation Transfer message. This message also contains the mobile equipment identifier (MEID) and the 1x Reference Cell ID corresponding to the cell that the eNodeB selected for fallback.

If the original MO call trigger did not pass through the 1x stack (PSIST check was not run at operation 2), the 1x stack will run a PSIST check before sending the GCSNA(ORM) to the LTE stack.

At operation 16, the eNodeB acts as a passthrough and forwards the GCSNA message to the MME in an S1: UL CDMA2000 Tunneling message. The message contains the cdma2000 SectorID. It also contains the RAND value since the UE would have used it to form the AUTH header. Since the GCSNA message was received in a UL-Handover Preparation Transfer message, the eNodeB adds two optional information elements (IEs).

The first IE is called CDMA2000 HO Required Indication IE. This IE allows the MME to recognize that preparation for handover has started and that it has to send some HO-related information to the IWS in the A21-1x Air Interface Signaling message.

The second IE is called CDMA2000 1xRTT SRVCC Info IE. One of the elements in this IE is the Pilot List that is formed using the 1x measurements the UE previously reported to the eNodeB (see [operation 13] and [operation 14]). This message contains the Pilot list IE which forms the measurements sent by the UE as well as the band classes supported by the UE. The other elements in the CDMA2000 1xRTT SRVCC Info IE are the MEID (learned from the UL Handover Preparation Transfer) and the CDMA2000 1xRTT Mobile Subscription Information. The latter is sent by the MME to the eNodeB as part of the S1: UE Initial Context Setup /S1: UE Context Modification.

At operation 17, using the cdma2000 Sector ID, the MME chooses the IWS. It encapsulates the GCSNA (ORM) message in an A21 message and populates the Pilot list IE in the A21 message based on the information received from the eNodeB. It also includes the RAND value and A21 mobile subscription information it received from the eNodeB.

At operation 18, the 1xIWS, 1x target BSC, and MSC interact to determine a Traffic Channel Assignment.

At operation 19, the 1xIWS forms a UHDM based on the traffic channel assignment. The UHDM is encapsulated in a GCSNA message that is sent using an A21-1x Air Interface message. The A21 message contains a GCSNA Status field which indicates that the HO procedure was successful. This status code differentiates it from A21 messages carrying other 1x messages.

At operation 20, the MME extracts the GCSNA message and sends a DL CDMA2000 tunneling message to the eNodeB. It maps the status code into the CDMA2000 HO Status IE in this message.

At operation 21, the eNodeB sends the GCSNA(UHDM) to the UE using the MobilityfromEUTRA message when the CDMA2000 HO Status IE indicates success.

At operation 22, the LTE stack extracts the GCSNA message and sends it to the 1x stack. The 1X stack extracts the UHDM and tunes to the 1x channel and pilots specified in the UHDM to start the voice call. The procedures are identical to a hard-handoff procedure. After the UE receives the BS-Ack in response to the Handoff completion message on native 1x, the LTE stack performs the operations specified in [operation 6] under MobilityFromEUTRA Success.

Upon receiving the S1: UE Context Release from the eNodeB, the UE context is suspended in the MME and the data session is suspended on the EPC.

After the voice call ends, the UE transitions to inactive (not idle). It triggers an MMS procedure (the aim is to reselect back to LTE, if available).

If the UE had transitioned to 1x idle (instead of inactive), it would have updated its registration status based on the SPM on 1x. This might lead to unnecessary registrations after each call. Hence, the approach is for the UE to move to inactive and attempt to move back to LTE. If the UE is in the coverage area of the same LTE network and the LTE cell advertises the same 1x zone as before, the UE will most likely not have to perform a 1x registration (a corner case that could result in the UE having to perform a registration is if the registration timer expired while the UE was on the call).

In the MMSS procedure, the UE will first scan MRU[0]. Since MRU[0] in this case will be LTE, the MMSS procedures will first attempt LTE.

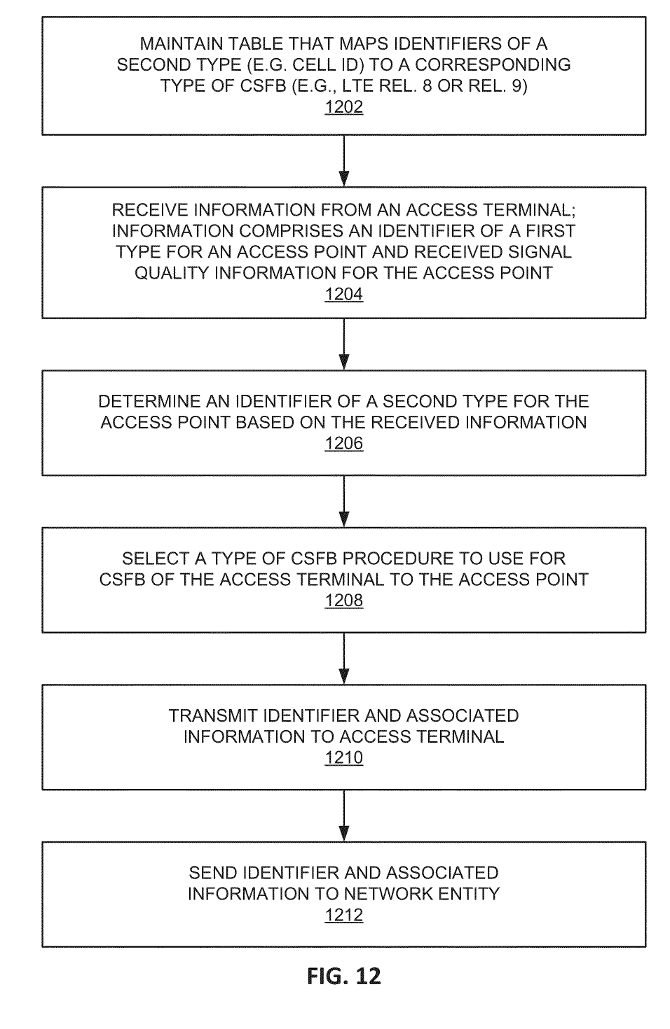

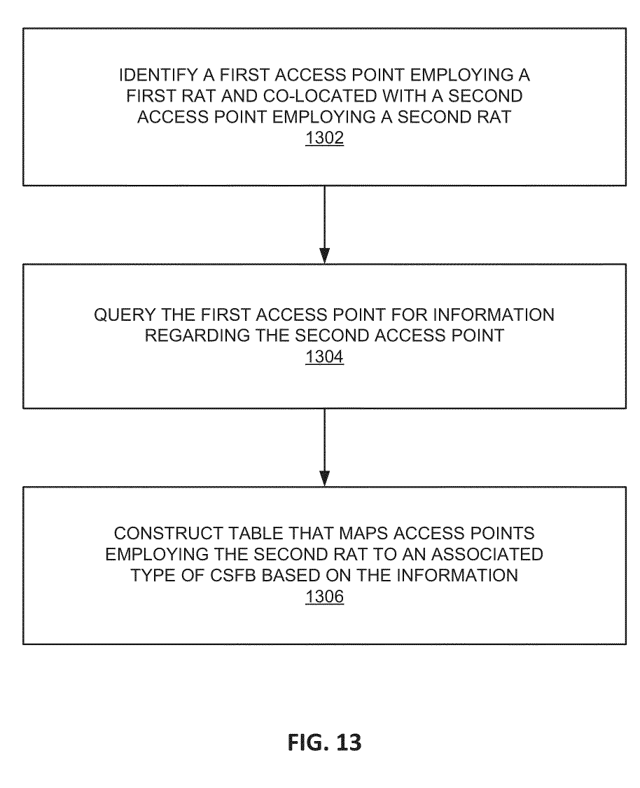

With the above in mind, additional details relating to supporting CSFB will now be described with reference to FIGS. 12 and 13.

FIG. 12 illustrates an example of operations that may be employed in conjunction with determining an identifier to be used for CSFB. For purposes of illustration, these operations may be described as being performed by a serving access point (e.g., a small cell eNodeB). It should be appreciated, however, that some of these operations may be performed by another entity. In some implementations, these operations may be performed at an apparatus that comprises co-located access points employing different radio access technologies (e.g., LTE and CDMA 1xRTT). It also should be appreciated that one or more of the operations described herein may not be employed in a given implementation.

As represented by block 1202, in some implementations, the serving access point maintains a table that serves to map different potential target access points with different types of CSFB. Specifically, for a given access point, the table maps the access point to the type of CSFB supported by that access point (e.g., supported by the MSC for that access point).

As discussed above, an access point may be assigned different types of identifiers. A local identifier such as a physical layer identifier (e.g., a PN) may uniquely identify an access point at a local level (e.g., within a macro cell). In addition, a global identifier such as a cell identifier (e.g., a Cell ID) may uniquely identify an access point at a more global level (e.g., within an operator's network). Since the first type of identifier is smaller in size, it may be more efficiently broadcast by an access point. Hence, this type of identifier is used locally to identify access points. Conversely, the second type of identifier may be used to uniquely identify the access point. Consequently this identifier may be sent to other entities in a wide area network, yet still unambiguously identify the access point.

Due to their global uniqueness, the serving access point uses identifiers of the second type for the CSFB table. That is, the table maps identifiers of a second type to a corresponding type of CSFB. For example, some identifiers may be mapped to LTE Rel. 8 CSFB, while other identifiers may be mapped to LTE Rel. 9 CSFB. As discussed below, this table is used to select a type of CSFB procedure to be used for CSFB of an access terminal served by the serving access point. Thus, in some aspects, the table may map access points employing the second radio access technology to an associated type of circuit switched fallback (e.g., LTE Rel. 8 CSFB or LTE Rel. 9 CSFB).

As represented by block 1204, at some point in time, the serving access point receives information from an access terminal currently being served by the access point. For example, the serving access point may receive a measurement report message that includes information about other access points seen by the access terminal. Accordingly, the received information may comprise an identifier of a first type (e.g., a local identifier) for a potential target access point along with received signal quality information for the potential target access point (e.g., received signal strength information as measured by the access terminal). In some aspects, block 1204 may correspond to operation 13 of FIG. 11.

As represented by block 1206, the serving access point determines an identifier of a second type for the potential target access point based on the information received at block 1204. As discussed above, the identifier of the second type may be used for circuit switched fallback (CSFB) of the access terminal to the access point. For example, this identifier may comprise a global identifier (e.g., the Reference Cell ID). In some aspects, block 1206 may correspond to operation 13b of FIG. 11.

As represented by block 1208, the serving access point selects a type of CSFB procedure to use for CSFB of the access terminal to the potential target access point. This operation is discussed in more detail below in conjunction with FIG. 13. CSFB of the access terminal may then proceed as discussed herein, if warranted.

As represented by block 1210, the serving access point may transmit the identifier determined at block 1206 and other information (e.g., information associated with this identifier) to the access terminal. For example, block 1210 may correspond to operation 14 of FIG. 11.

As represented by block 1212, the serving access point may send the identifier determined at block 1206 and other information (e.g., information associated with this identifier) to a network entity (e.g., the serving access point's MME). For example, block 1212 may correspond to operations 15b and 16 of FIG. 11.

FIG. 13 illustrates an example of operations that may be employed in conjunction with a hybrid ANR procedure. As discussed above, this procedure enables an access point (e.g., an LTE small cell co-located with a CDMA 1xRTT small cell) to discover another 1x small cell that is co-located with another LTE small cell.

As represented by block 1302, the access point identifies a first access point employing a first radio access technology (RAT) and co-located with a second access point employing a second radio access technology. For example, the access point may use LTE intra-RAT automatic neighbor relations (ANR) to discover another LTE small cell.

As represented by block 1304, the access point queries the first access point for information regarding the second access point. In some aspects, this query may employ a backhaul protocol. Typically, the query will request that a local identifier (e.g., PN) and/or a global identifier (e.g. Cell ID) of the second access point be reported back. In various implementations, the access points may communicate via a proprietary protocol, via an access point to access point protocol, via one or more third parties, or via some other protocol.

The queried information may take different forms in different implementations. In some aspects, the information may comprise a local identifier (e.g., a physical layer identifier) for the second access point. In some aspects, the information may comprise a global identifier (e.g., a cell identifier) for the second access point.

As represented by block 1306, the access point constructs a table based on the information received at block 1304. For example, the access point may add the identifier information to the table, along with information regarding the CSFB procedure supported by the corresponding access point (e.g., obtained from the core network). In some aspects, the table may map access points employing the second radio access technology to an associated type of circuit switched fallback (e.g., LTE Rel. 8 CSFB or LTE Rel. 9 CSFB).

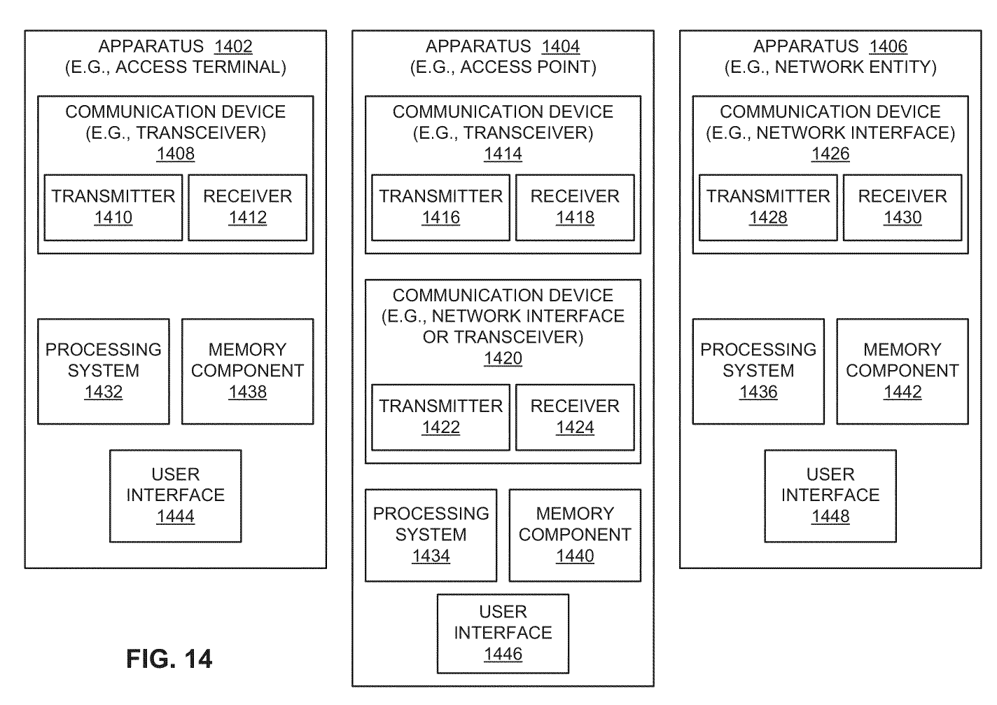

FIG. 14 illustrates several sample components (represented by corresponding blocks) that may be incorporated into an apparatus 1402, an apparatus 1404, and an apparatus 1406 (e.g., corresponding to an access terminal, an access point, and a network entity, respectively) to support CSFB as taught herein. It should be appreciated that these components may be implemented in different types of apparatuses in different implementations (e.g., in an ASIC, in an SoC, etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 1402 and the apparatus 1404 each include at least one wireless communication device (represented by the communication devices 1408 and 1414 (and the communication device 1420 if the apparatus 1404 is a relay)) for communicating with other nodes via at least one designated radio access technology. Each communication device 1408 includes at least one transmitter (represented by the transmitter 1410) for transmitting and encoding signals (e.g., messages, indications, information, and so on) and at least one receiver (represented by the receiver 1412) for receiving and decoding signals (e.g., messages, indications, information, pilots, and so on). Similarly, each communication device 1414 includes at least one transmitter (represented by the transmitter 1416) for transmitting signals (e.g., messages, indications, information, pilots, and so on) and at least one receiver (represented by the receiver 1418) for receiving signals (e.g., messages, indications, information, and so on). If the apparatus 1404 is a relay access point, each communication device 1420 may include at least one transmitter (represented by the transmitter 1422) for transmitting signals (e.g., messages, indications, information, pilots, and so on) and at least one receiver (represented by the receiver 1424) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 1404 comprises a network listen module.

The apparatus 1406 (and the apparatus 1404 if it is not a relay access point) includes at least one communication device (represented by the communication device 1426 and, optionally, 1420) for communicating with other nodes. For example, the communication device 1426 may comprise a network interface that is configured to communicate with one or more network entities via a wire-based or wireless backhaul. In some aspects, the communication device 1426 may be implemented as a transceiver configured to support wire-based or wireless signal communication. This communication may involve, for example, sending and receiving: messages, parameters, or other types of information. Accordingly, in the example of FIG. 14, the communication device 1426 is shown as comprising a transmitter 1428 and a receiver 1430. Similarly, if the apparatus 1404 is not a relay access point, the communication device 1420 may comprise a network interface that is configured to communicate with one or more network entities via a wire-based or wireless backhaul. As with the communication device 1426, the communication device 1420 is shown as comprising a transmitter 1422 and a receiver 1424.

The apparatuses 1402, 1404, and 1406 also include other components that may be used in conjunction with CSFB operations as taught herein. The apparatus 1402 includes a processing system 1432 for providing functionality relating to, for example, CSFB operations (e.g., falling back to a CS access point) as taught herein and for providing other processing functionality. The apparatus 1404 includes a processing system 1434 for providing functionality relating to, for example, CSFB operations (e.g., one or more of: determining identifiers, maintaining a table, selecting a type of CSFB procedure, identifying an access point, controlling querying of an access point, or constructing a table) as taught herein and for providing other processing functionality. The apparatus 1406 includes a processing system 1436 for providing functionality relating to, for example, CSFB operations (e.g., one or more of: determining identifiers, maintaining a table, selecting a type of CSFB procedure, identifying an access point, controlling querying of an access point, or constructing a table) as taught herein and for providing other processing functionality. The apparatuses 1402, 1404, and 1406 include memory devices 1438, 1440, and 1442 (e.g., each including a memory device), respectively, for maintaining information (e.g., information, thresholds, parameters, and so on). In addition, the apparatuses 1402, 1404, and 1406 include user interface devices 1444, 1446, and 1448, respectively, for providing indications (e.g., audible and/or visual indications) to a user and/or for receiving user input (e.g., upon user actuation of a sensing device such a keypad, a touch screen, a microphone, and so on).

For convenience, the apparatus 1402 is shown in FIG. 14 as including components that may be used in the various examples described herein. In practice, the illustrated blocks may have different functionality in different aspects. For example, functionality of the block 1434 for supporting the operations of FIG. 4 may be different as compared to functionality of the block 1434 for supporting the operations of FIG. 12.

The components of FIG. 14 may be implemented in various ways. In some implementations, the components of FIG. 14 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1408, 1432, 1438, and 1444 may be implemented by processor and memory component(s) of the apparatus 1402 (e.g., by execution of appropriate code and/or by appropriate configuration of processor components). Similarly, some or all of the functionality represented by blocks 1414, 1420, 1434, 1440, and 1446 may be implemented by processor and memory component(s) of the apparatus 1404 (e.g., by execution of appropriate code and/or by appropriate configuration of processor components). Also, some or all of the functionality represented by blocks 1426, 1436, 1442, and 1448 may be implemented by processor and memory component(s) of the apparatus 1406 (e.g., by execution of appropriate code and/or by appropriate configuration of processor components).

As mentioned above, some of the access points referred to herein may comprise low-power access points. As used herein, the term low-power access point refers to an access point having a transmit power (e.g., one or more of: maximum transmit power, instantaneous transmit power, nominal transmit power, average transmit power, or some other form of transmit power) that is less than a transmit power (e.g., as defined above) of any macro access point in the coverage area. In some implementations, each low-power access point has a transmit power (e.g., as defined above) that is less than a transmit power (e.g., as defined above) of the macro access point by a relative margin (e.g., 10 dBm or more). In some implementations, low-power access points such as femto cells may have a maximum transmit power of 20 dBm or less. In some implementations, low-power access points such as pico cells may have a maximum transmit power of 24 dBm or less. It should be appreciated, however, that these or other types of low-power access points may have a higher or lower maximum transmit power in other implementations (e.g., up to 1 Watt in some cases, up to 10 Watts in some cases, and so on).

Typically, low-power access points connect to the Internet via a broadband connection (e.g., a digital subscriber line (DSL) router, a cable modem, or some other type of modem) that provides a backhaul link to a mobile operator's network. Thus, a low-power access point deployed in a user's home or business provides mobile network access to one or more devices via the broadband connection.

Small cells may be configured to support different types of access modes. For example, in an open access mode, a small cell may allow any access terminal to obtain any type of service via the small cell. In a restricted (or closed) access mode, a small cell may only allow authorized access terminals to obtain service via the small cell. For example, a small cell may only allow access terminals (e.g., so called home access terminals) belonging to a certain subscriber group (e.g., a closed subscriber group (CSG)) to obtain service via the small cell. In a hybrid access mode, alien access terminals (e.g., non-home access terminals, non-CSG access terminals) may be given limited access to the small cell. For example, a macro access terminal that does not belong to a small cell's CSG may be allowed to access the small cell only if sufficient resources are available for all home access terminals currently being served by the small cell.

Thus, small cells operating in one or more of these access modes may be used to provide indoor coverage and/or extended outdoor coverage. By allowing access to users through adoption of a desired access mode of operation, small cells may provide improved service within the coverage area and potentially extend the service coverage area for users of a macro network.

Thus, in some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a small cell. It should be appreciated that the teachings herein may be applicable to nodes associated with other types of coverage areas. For example, a pico access point may provide coverage (e.g., coverage within a commercial building) over an area that is smaller than a macro area and larger than a femto cell area. In various applications, other terminology may be used to reference a macro access point, a small cell, or other access point-type nodes. For example, a macro access point may be configured or referred to as an access node, base station, access point, eNodeB, macro cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

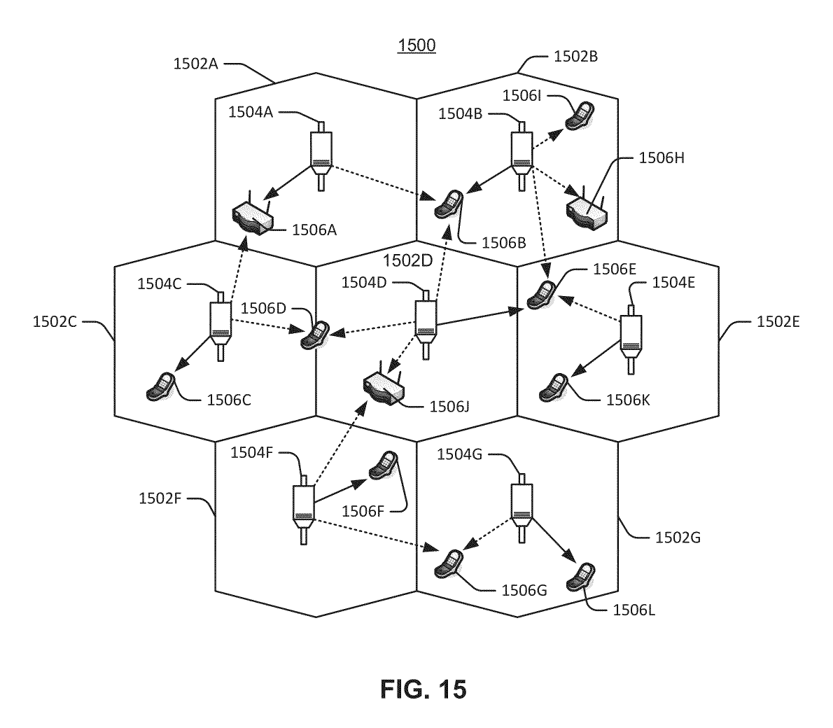

FIG. 15 illustrates a wireless communication system 1500, configured to support a number of users, in which the teachings herein may be implemented. The system 1500 provides communication for multiple cells 1502, such as, for example, macro cells 1502A-1502G, with each cell being serviced by a corresponding access point 1504 (e.g., access points 1504A-1504G). As shown in FIG. 15, access terminals 1506 (e.g., access terminals 1506A-1506L) may be dispersed at various locations throughout the system over time. Each access terminal 1506 may communicate with one or more access points 1504 on a forward link (FL) and/or a reverse link (RL) at a given moment, depending upon whether the access terminal 1506 is active and whether it is in soft handoff, for example. The wireless communication system 1500 may provide service over a large geographic region. For example, macro cells 1502A-1502G may cover a few blocks in a neighborhood or several miles in a rural environment.

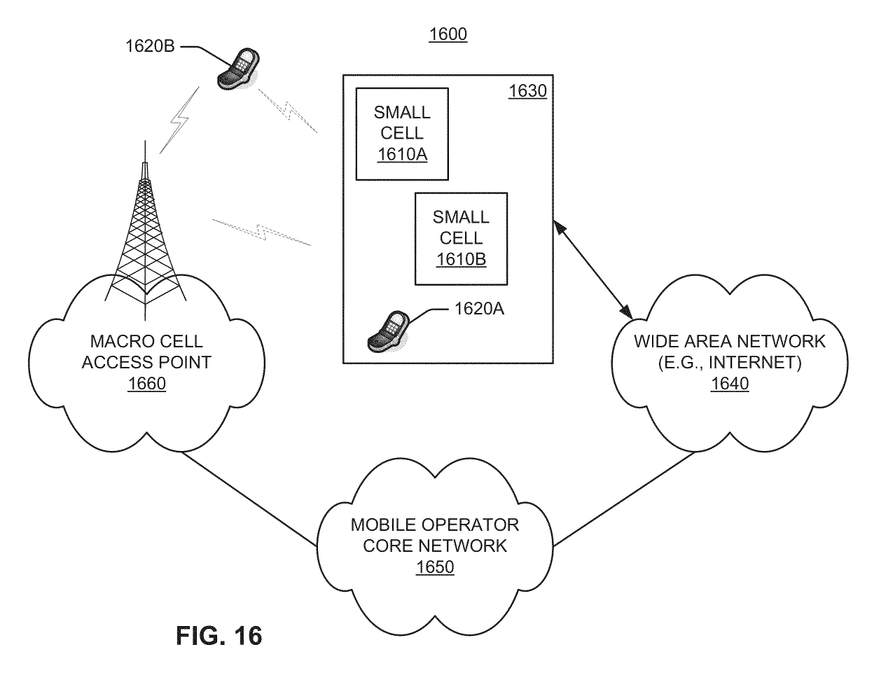

FIG. 16 illustrates an example of a communication system 1600 where one or more small cells are deployed within a network environment. Specifically, the system 1600 includes multiple small cells 1610 (e.g., small cells 1610A and 1610B) installed in a relatively small scale network environment (e.g., in one or more user residences 1630). Each small cell 1610 may be coupled to a wide area network 1640 (e.g., the Internet) and a mobile operator core network 1650 via a DSL router, a cable modem, a wireless link, or other connectivity means (not shown). As will be discussed below, each small cell 1610 may be configured to serve associated access terminals 1620 (e.g., access terminal 1620A) and, optionally, other (e.g., hybrid or alien) access terminals 1620 (e.g., access terminal 1620B). In other words, access to small cells 1610 may be restricted whereby a given access terminal 1620 may be served by a set of designated (e.g., home) small cell(s) 1610 but may not be served by any non-designated small cells 1610 (e.g., a neighbor's small cell 1610).

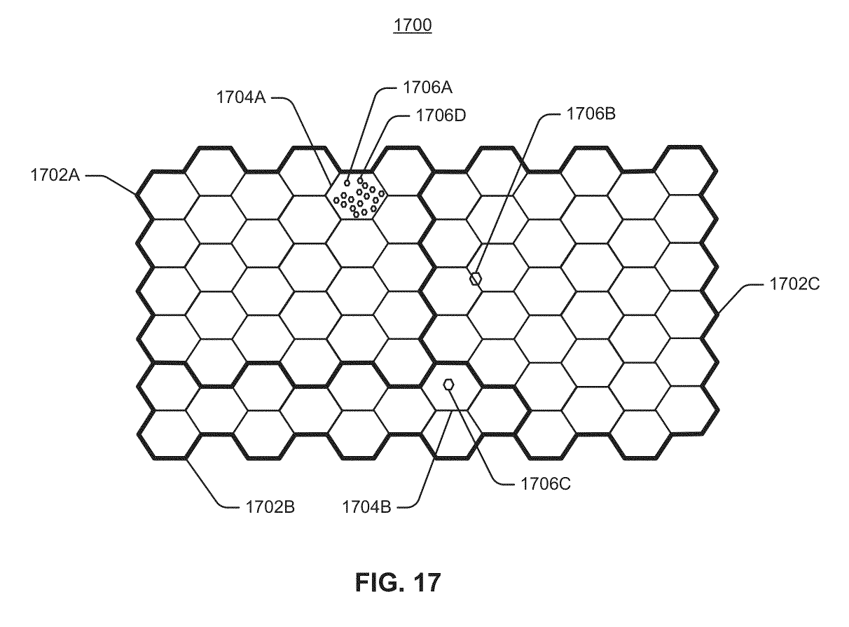

FIG. 17 illustrates an example of a coverage map 1700 where several tracking areas 1702 (or routing areas or location areas) are defined, each of which includes several macro coverage areas 1704. Here, areas of coverage associated with tracking areas 1702A, 1702B, and 1702C are delineated by the wide lines and the macro coverage areas 1704 are represented by the larger hexagons. The tracking areas 1702 also include femto coverage areas 1706. In this example, each of the femto coverage areas 1706 (e.g., femto coverage areas 1706B and 1706C) is depicted within one or more macro coverage areas 1704 (e.g., macro coverage areas 1704A and 1704B). It should be appreciated, however, that some or all of a femto coverage area 1706 might not lie within a macro coverage area 1704. In practice, a large number of femto coverage areas 1706 (e.g., femto coverage areas 1706A and 1706D) may be defined within a given tracking area 1702 or macro coverage area 1704. Also, one or more pico coverage areas (not shown) may be defined within a given tracking area 1702 or macro coverage area 1704.

Referring again to FIG. 16, the owner of a small cell 1610 may subscribe to mobile service, such as, for example, 3G mobile service, offered through the mobile operator core network 1650. In addition, an access terminal 1620 may be capable of operating both in macro environments and in smaller scale (e.g., residential) network environments. In other words, depending on the current location of the access terminal 1620, the access terminal 1620 may be served by a macro cell access point 1660 associated with the mobile operator core network 1650 or by any one of a set of small cells 1610 (e.g., the small cells 1610A and 1610B that reside within a corresponding user residence 1630). For example, when a subscriber is outside his home, he is served by a standard macro access point (e.g., access point 1660) and when the subscriber is at home, he is served by a small cell (e.g., small cell 1610A). Here, a small cell 1610 may be backward compatible with legacy access terminals 1620.

A small cell 1610 may be deployed on a single frequency or, in the alternative, on multiple frequencies. Depending on the particular configuration, the single frequency or one or more of the multiple frequencies may overlap with one or more frequencies used by a macro access point (e.g., access point 1660).

In some aspects, an access terminal 1620 may be configured to connect to a preferred small cell (e.g., the home small cell of the access terminal 1620) whenever such connectivity is possible. For example, whenever the access terminal 1620A is within the user's residence 1630, it may be desired that the access terminal 1620A communicate only with the home small cell 1610A or 1610B.

In some aspects, if the access terminal 1620 operates within the macro cellular network 1650 but is not residing on its most preferred network (e.g., as defined in a preferred roaming list), the access terminal 1620 may continue to search for the most preferred network (e.g., the preferred small cell 1610) using a better system reselection (BSR) procedure, which may involve a periodic scanning of available systems to determine whether better systems are currently available and subsequently acquire such preferred systems. The access terminal 1620 may limit the search for specific band and channel. For example, one or more femto channels may be defined whereby all small cells (or all restricted small cells) in a region operate on the femto channel(s). The search for the most preferred system may be repeated periodically. Upon discovery of a preferred small cell 1610, the access terminal 1620 selects the small cell 1610 and registers on it for use when within its coverage area.

Access to a small cell may be restricted in some aspects. For example, a given small cell may only provide certain services to certain access terminals. In deployments with so-called restricted (or closed) access, a given access terminal may only be served by the macro cell mobile network and a defined set of small cells (e.g., the small cells 1610 that reside within the corresponding user residence 1630). In some implementations, an access point may be restricted to not provide, for at least one node (e.g., access terminal), at least one of: signaling, data access, registration, paging, or service.

In some aspects, a restricted small cell (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., small cells) that share a common access control list of access terminals.

Various relationships may thus exist between a given small cell and a given access terminal. For example, from the perspective of an access terminal, an open small cell may refer to a small cell with unrestricted access (e.g., the small cell allows access to any access terminal). A restricted small cell may refer to a small cell that is restricted in some manner (e.g., restricted for access and/or registration). A home small cell may refer to a small cell on which the access terminal is authorized to access and operate on (e.g., permanent access is provided for a defined set of one or more access terminals). A hybrid (or guest) small cell may refer to a small cell on which different access terminals are provided different levels of service (e.g., some access terminals may be allowed partial and/or temporary access while other access terminals may be allowed full access). An alien small cell may refer to a small cell on which the access terminal is not authorized to access or operate on, except for perhaps emergency situations (e.g., 911 calls).

From a restricted small cell perspective, a home access terminal may refer to an access terminal that is authorized to access the restricted small cell installed in the residence of that access terminal's owner (usually the home access terminal has permanent access to that small cell). A guest access terminal may refer to an access terminal with temporary access to the restricted small cell (e.g., limited based on deadline, time of use, bytes, connection count, or some other criterion or criteria). An alien access terminal may refer to an access terminal that does not have permission to access the restricted small cell, except for perhaps emergency situations, for example, such as 911 calls (e.g., an access terminal that does not have the credentials or permission to register with the restricted small cell).

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}<min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

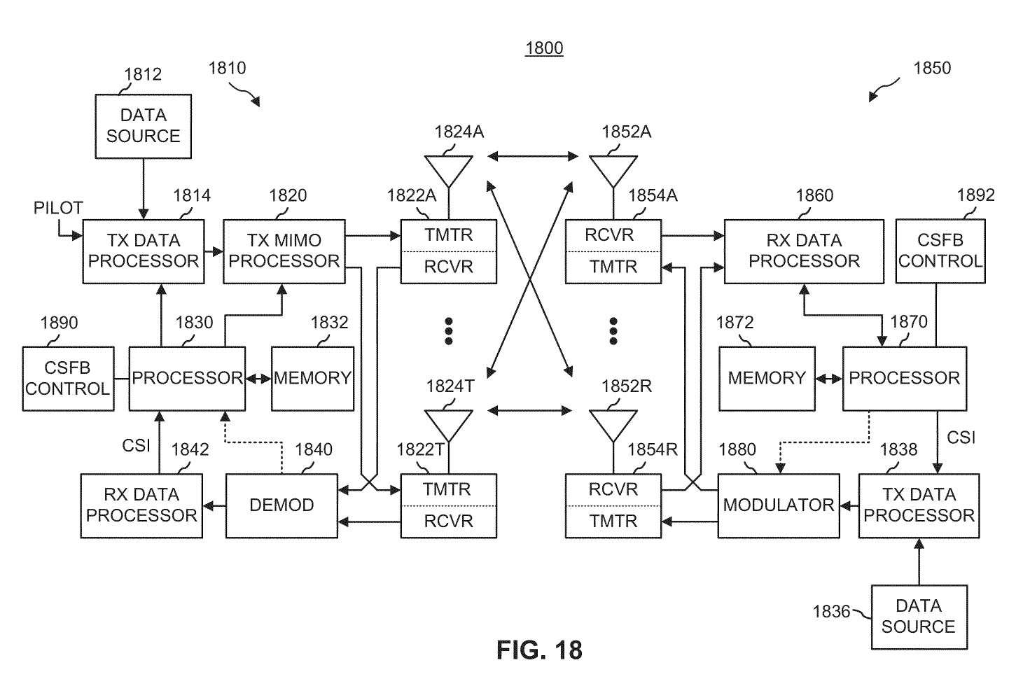

FIG. 18 illustrates a wireless device 1810 (e.g., an access point) and a wireless device 1850 (e.g., an access terminal) of a sample MIMO system 1800. At the device 1810, traffic data for a number of data streams is provided from a data source 1812 to a transmit (TX) data processor 1814. Each data stream may then be transmitted over a respective transmit antenna.

The TX data processor 1814 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1830. A data memory 1832 may store program code, data, and other information used by the processor 1830 or other components of the device 1810.

The modulation symbols for all data streams are then provided to a TX MIMO processor 1820, which may further process the modulation symbols (e.g., for OFDM). The TX MIMO processor 1820 then provides N_{T} modulation symbol streams to N_{T} transceivers (XCVR) 1822A through 1822T. In some aspects, the TX MIMO processor 1820 applies beam-forming weights to the symbols of the data streams and to the antenna from which the symbol is being transmitted.

Each transceiver 1822 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1822A through 1822T are then transmitted from N_{T} antennas 1824A through 1824T, respectively.

At the device 1850, the transmitted modulated signals are received by N_{R} antennas 1852A through 1852R and the received signal from each antenna 1852 is provided to a respective transceiver (XCVR) 1854A through 1854R. Each transceiver 1854 conditions (e.g., filters, amplifies, and downconverts) a respective received signal, digitizes the conditioned signal to provide samples, and further processes the samples to provide a corresponding “received” symbol stream.

A receive (RX) data processor 1860 then receives and processes the N_{R} received symbol streams from N_{R} transceivers 1854 based on a particular receiver processing technique to provide N_{T} “detected” symbol streams. The RX data processor 1860 then demodulates, deinterleaves, and decodes each detected symbol stream to recover the traffic data for the data stream. The processing by the RX data processor 1860 is complementary to that performed by the TX MIMO processor 1820 and the TX data processor 1814 at the device 1810.

A processor 1870 periodically determines which pre-coding matrix to use (discussed below). The processor 1870 formulates a reverse link message comprising a matrix index portion and a rank value portion. A data memory 1872 may store program code, data, and other information used by the processor 1870 or other components of the device 1850.

The reverse link message may comprise various types of information regarding the communication link and/or the received data stream. The reverse link message is then processed by a TX data processor 1838, which also receives traffic data for a number of data streams from a data source 1836, modulated by a modulator 1880, conditioned by the transceivers 1854A through 1854R, and transmitted back to the device 1810.

At the device 1810, the modulated signals from the device 1850 are received by the antennas 1824, conditioned by the transceivers 1822, demodulated by a demodulator (DEMOD) 1840, and processed by a RX data processor 1842 to extract the reverse link message transmitted by the device 1850. The processor 1830 then determines which pre-coding matrix to use for determining the beam-forming weights then processes the extracted message.

FIG. 18 also illustrates that the communication components may include one or more components that perform CSFB control operations as taught herein. For example, a CSFB control component 1890 may cooperate with the processor 1830 and/or other components of the device 1810 to control CSFB of another device (e.g., device 1850) as taught herein. Similarly, a CSFB control component 1892 may cooperate with the processor 1870 and/or other components of the device 1850 to perform CSFB. It should be appreciated that for each device 1810 and 1850 the functionality of two or more of the described components may be provided by a single component. For example, a single processing component may provide the functionality of the CSFB control component 1890 and the processor 1830 and a single processing component may provide the functionality of the CSFB control component 1892 and the processor 1870.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects, a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects, the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

The functionality described herein (e.g., with regard to one or more of the accompanying figures) may correspond in some aspects to similarly designated “means for” functionality in the appended claims.

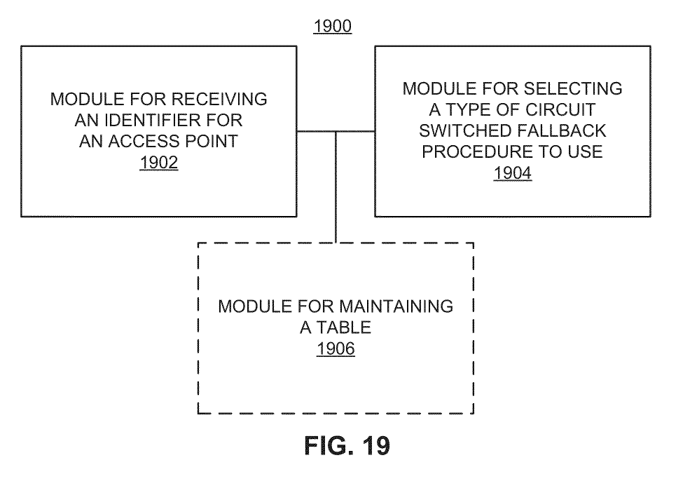

Referring to FIG. 19, an apparatus 1900 is represented as a series of interrelated functional modules. Here, a module for receiving an identifier for an access point 1902 may correspond at least in some aspects to, for example, a receiver and/or a transceiver as discussed herein. A module for selecting a type of circuit switched fallback procedure to use 1904 may correspond at least in some aspects to, for example, a processing system as discussed herein. A module for maintaining a table 1906 may correspond at least in some aspects to, for example, a memory device and/or a processing system as discussed herein.

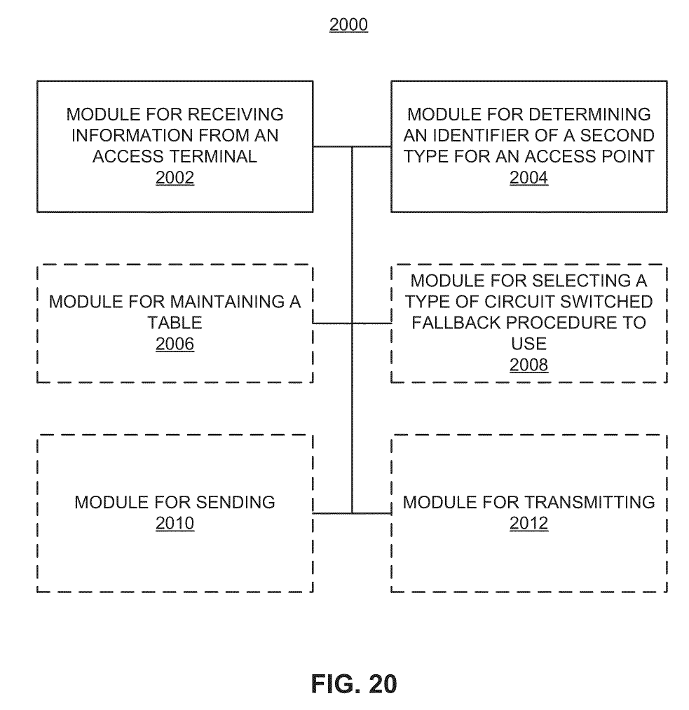

Referring to FIG. 20, an apparatus 2000 is represented as a series of interrelated functional modules. Here, a module for receiving information from an access terminal 2002 may correspond at least in some aspects to, for example, a receiver as discussed herein. A module for determining an identifier of a second type for an access point 2004 may correspond at least in some aspects to, for example, a processing system as discussed herein. A module for maintaining a table 2006 may correspond at least in some aspects to, for example, a processing system as discussed herein. A module for selecting a type of circuit switched fallback procedure to use 2008 may correspond at least in some aspects to, for example, a processing system as discussed herein. A module for sending 2010 may correspond at least in some aspects to, for example, a communication device as discussed herein. A module for transmitting 2012 may correspond at least in some aspects to, for example, a transmitter as discussed herein.

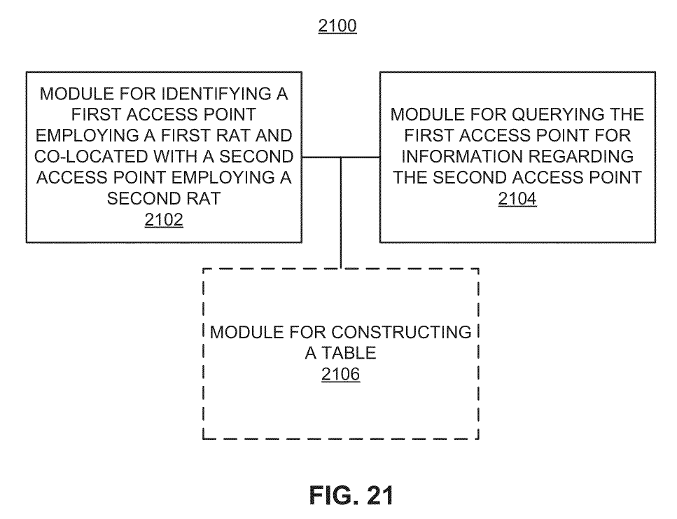

Referring to FIG. 21, an apparatus 2100 is represented as a series of interrelated functional modules. Here, a module for identifying a first access point employing a first RAT and co-located with a second access point employing a RAT 2102 may correspond at least in some aspects to, for example, a processing system as discussed herein. A module for querying the first access point for information regarding the second access point 2104 may correspond at least in some aspects to, for example, a communication device as discussed herein. A module for constructing a table 2106 may correspond at least in some aspects to, for example, a processing system as discussed herein.

The functionality of the modules of FIGS. 19-21 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. As one specific example, the apparatus 2000 may comprise a single device (e.g., components 2002-2012 comprising different sections of an ASIC). As another specific example, the apparatus 2000 may comprise several devices (e.g., the components 2002 and 2012 comprising one ASIC, the components 2004-2008 comprising another ASIC, and the component 2010 comprising yet another ASIC). The functionality of these modules also may be implemented in some other manner as taught herein. In some aspects one or more of any dashed blocks in FIGS. 19-21 are optional.

In addition, the components and functions represented by FIGS. 19-21 as well as other components and functions described herein, may be implemented using any suitable means. Such means also may be implemented, at least in part, using corresponding structure as taught herein. For example, the components described above in conjunction with the “module for” components of FIGS. 19-21 also may correspond to similarly designated “means for” functionality. Thus, in some aspects one or more of such means may be implemented using one or more of processor components, integrated circuits, or other suitable structure as taught herein.

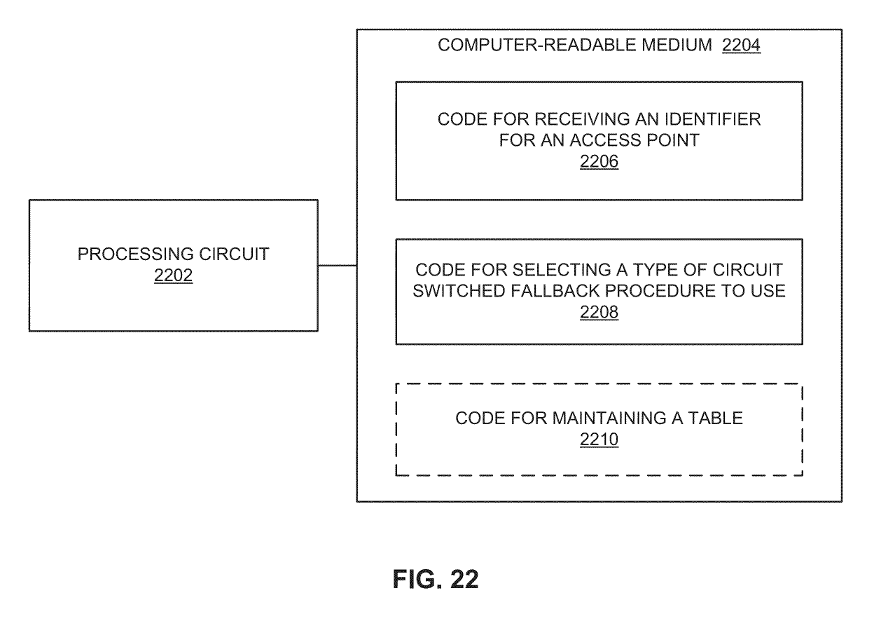

FIG. 22 is a simplified block diagram of several sample aspects of a processing circuit 2202 coupled to a computer-readable medium 2204 that may be configured to support CSFB as taught herein. The processing circuit 2202 is generally arranged to obtain, process and/or send data, control data access and storage, issue commands, and control other desired operations, and may comprise circuitry configured to implement desired programming provided by appropriate media, such as computer-readable medium 2204, in at least one implementation.

The computer-readable medium 2204 may represent media for storing programming and/or data, such as processor executable code or instructions (e.g., software, firmware), electronic data, databases, or other digital information. The computer-readable medium 2204 may be coupled to the processing circuit 2202 such that the processing circuit 2202 can read information from, and write information to, the computer-readable medium 2204. In the alternative, the computer-readable medium 2204 may be integral to the processing circuit 2202. The computer-readable medium 2204 can include code for receiving an identifier for an access point 2206 and code for selecting a type of circuit switched fallback procedure to use 2208. In addition, the computer-readable medium 2204 can include code for maintaining a table 2210.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm operations described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of operations in any disclosed process is an example of a sample approach. Based upon design preferences, it is understood that the specific order or hierarchy of operations in the processes may be rearranged while remaining within the scope of the present disclosure. The accompanying method claims present elements of the various operations in a sample order, and are not meant to be limited to the specific order or hierarchy presented.

The operations of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code(s) executable (e.g., executable by at least one computer) to provide functionality relating to one or more of the aspects of the disclosure. In some aspects, a computer program product may comprise packaging materials.

In one or more implementations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for communication, comprising:
a receiver configured to receive an identifier for an access point from an access terminal; and
a processing system configured to select, based on the received identifier, a type of circuit switched fallback procedure to use for circuit switched fallback of the access terminal to the access point.

2. The apparatus of claim 1, wherein the selection of the type of circuit switched fallback procedure comprises selecting between LTE Rel. 8 circuit switched fallback and LTE Rel. 9 circuit switched fallback.

3. The apparatus of claim 1, wherein the processing system is further configured to maintain a table that maps access point identifiers to a corresponding type of circuit switched fallback.

4. The apparatus of claim 3, wherein the processing system is further configured to provision the table.

5. The apparatus of claim 4, wherein the provisioning of the table comprises receiving table information from a configuration management entity.

6. The apparatus of claim 3, wherein the table indicates, for each of the access point identifiers, whether an access point associated with the access point identifier supports LTE Rel. 8 circuit switched fallback or LTE Rel. 9 circuit switched fallback.

7. The apparatus of claim 3, wherein the selection of the type of circuit switched fallback procedure is further based on the table.

8. The apparatus of claim 1, wherein the identifier comprises a global identifier that is unique within an operator network.

9. The apparatus of claim 1, wherein the apparatus comprises co-located access points employing different radio access technologies.

10. The apparatus of claim 9, wherein the different radio access technologies comprises LTE and CDMA 1xRTT.

11. A method of communication, comprising:
receiving an identifier for an access point from an access terminal; and
selecting, based on the received identifier, a type of circuit switched fallback procedure to use for circuit switched fallback of the access terminal to the access point.

12. The method of claim 11, wherein the selection of the type of circuit switched fallback procedure comprises selecting between LTE Rel. 8 circuit switched fallback and LTE Rel. 9 circuit switched fallback.

13. The method of claim 11, further comprising maintaining a table that maps access point identifiers to a corresponding type of circuit switched fallback.

14. The method of claim 13, further comprising provisioning the table.

15. The method of claim 14, wherein the provisioning of the table comprises receiving table information from a configuration management entity.

16. The method of claim 13, wherein the table indicates, for each of the access point identifiers, whether an access point associated with the access point identifier supports LTE Rel. 8 circuit switched fallback or LTE Rel. 9 circuit switched fallback.

17. The method of claim 13, wherein the selection of the type of circuit switched fallback procedure is further based on the table.

18. The method of claim 11, wherein the identifier comprises a global identifier that is unique within an operator network.

19. The method of claim 11, wherein the method is performed at an apparatus that comprises co-located access points employing different radio access technologies.

20. The method of claim 19, wherein the different radio access technologies comprises LTE and CDMA 1xRTT.

21. An apparatus for communication, comprising:
means for receiving an identifier for an access point from an access terminal; and
means for selecting, based on the received identifier, a type of circuit switched fallback procedure to use for circuit switched fallback of the access terminal to the access point.

22. The apparatus of claim 21, wherein the selection of the type of circuit switched fallback procedure comprises selecting between LTE Rel. 8 circuit switched fallback and LTE Rel. 9 circuit switched fallback.

23. A computer-program product, comprising:
computer-readable medium comprising code for causing a computer to:
receive an identifier for an access point from an access terminal; and
select, based on the received identifier, a type of circuit switched fallback procedure to use for circuit switched fallback of the access terminal to the access point.

24. The computer-program product of claim 23, wherein the selection of the type of circuit switched fallback procedure comprises selecting between LTE Rel. 8 circuit switched fallback and LTE Rel. 9 circuit switched fallback.
